(19) United States
(12) Patent Application Publication
(10) Pub. No.: US 2025/0047017 A1
(43) Pub. Date: Feb. 6, 2025

(54) ELECTRICAL CONNECTION DEVICE

(71) Applicant: SUMITOMO WIRING SYSTEMS, LTD., Mie (JP)

(72) Inventor: Tokuko TOKI, Mie (JP)

(21) Appl. No.: 18/772,722

(22) Filed: Jul. 15, 2024

(30) Foreign Application Priority Data
Jul. 31, 2023 (JP) 2023-124344

(51) Int. Cl. H01R 9/22; H01R 9/24

(52) U.S. Cl. CPC H01R 9/223; H01R 9/2491

(57) ABSTRACT

An electrical connection device includes a resin base 22, a terminal 30 including an insert part 32 located in the resin base 22, and a sealing portion 40 interposed between the insert part and the resin base 22. The sealing portion is a thermally shrunk heat shrink tube in a state covering the insert part.

### CROSS-REFERENCE TO RELATED APPLICATIONS

This application is based on and claims priority from Japanese Patent Application No. 2023-124344, filed on Jul. 31, 2023, with the Japan Patent Office, the disclosure of which is incorporated herein in its entirety by reference.

### TECHNICAL FIELD

The present disclosure relates to an electrical connection device.

### BACKGROUND

Japanese Patent Laid-open Publication No. 2017-147147 discloses a terminal block including a housing having a resin portion, a busbar and a sealing portion. In Japanese Patent Laid-open Publication No. 2017-147147, the sealing portion is constituted by an adhesive sheet.

### SUMMARY

Here, it is desired to more facilitate the mounting of the sealing portion on the busbar.

Accordingly, the present disclosure aims to easily mount a sealing portion on a terminal in an electrical connection device.

The present disclosure is directed to an electrical connection device with a resin base, a terminal including an insert part located in the resin base, and a sealing portion interposed between the insert part and the resin base, the sealing portion being a thermally shrunk heat shrink tube in a state covering the insert part.

According to the present disclosure, a sealing portion is easily mounted on a terminal in an electrical connection device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view showing a terminal block.

FIG. 2 is a perspective view showing the terminal block.

FIG. 3 is a section along III-III of FIG. 1.

FIG. 4 is a section along IV-IV of FIG. 2.

FIG. 5 is a perspective view showing a terminal and a sealing portion.

FIG. 6 is a diagram showing an operation example of inserting the terminal through a heat shrink tube.

FIG. 7 is a diagram showing a setting example of the terminal and the sealing portion in a mold.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF PRESENT DISCLOSURE

Embodiments of the present disclosure are first listed and described.

The electrical connection device of the present disclosure is as follows.

(1) The electrical connection device of the present disclosure is provided with a resin base, a terminal including an insert part located in the resin base, and a sealing portion interposed between the insert part and the resin base, the sealing portion being a thermally shrunk heat shrink tube in a state covering the insert part.

According to this electrical connection device, the sealing portion is the thermally shrunk heat shrink tube in the state covering the insert part. Thus, if the heat shrink tube is thermally shrunk by heating after the terminal is passed through the heat shrink tube before thermal shrinkage, the heat shrink tube can be easily mounted on the terminal. Thus, the mounting of the sealing portion on the terminal is facilitated. Further, since the heat shrink tube uniformly surrounds the insert part, sealability can be expected to improve.

(2) In the electrical connection device of (1), the terminal may include a first end part and a second end part and the insert part may be located between the first and second end parts, and the insert part may be located in the resin base with the first and second end parts exposed from the resin base.

In this case, by electrically connecting the first and second end parts to separate electrically conductive paths, the separate electrically conductive paths are electrically connected via the terminal. The sealing portion for providing sealability to the terminal for relay-connecting the separate electrically conductive paths can be easily mounted on the insert part.

(3) In the electrical connection device of (2), the resin base may include a mounting portion to be mounted on a device case to close a connection opening of the device case, and the terminal may be so supported in the resin base that the first end part is facing outward of the device case and the second end part is facing inward of the device case through the connection opening with the resin base mounted on the device case.

In this case, the terminal is passed through the resin base with the resin base covering the connection opening. Using this terminal, the electrically conductive path inside the device case and the electrically conductive path outside the device case are electrically connected. In this case, the intrusion of a fluid along the terminal passed through the resin base through the opening is suppressed by the sealing portion. Thus, sealability is improved inside and outside the device case.

(4) In the electrical connection device of any one of (1) to (3), the entire sealing portion may be covered in the resin base.

In this case, a boundary between the terminal and the sealing portion is covered in the resin base. Thus, the intrusion of the fluid along the terminal is more reliably suppressed.

### DETAILS OF EMBODIMENT OF PRESENT DISCLOSURE

A specific example of an electrical connection device of the present disclosure is described below with reference to the drawings. Note that the present disclosure is not limited to these illustrations, but is represented by claims and intended to include all changes in the scope of claims and in the meaning and scope of equivalents.

### Embodiment

Hereinafter, an electrical connection device according to an embodiment is described. In this embodiment, an example in which the electrical connection device is a terminal block is described. The terminal block is a component to be fixed to a device for electrically connecting this device to another electrical device. A terminal is a component for electrical connection and one type of wiring component. The device may be, for example, a rotating electric device, an inverter, a battery, a DC-DC converter or a junction box.

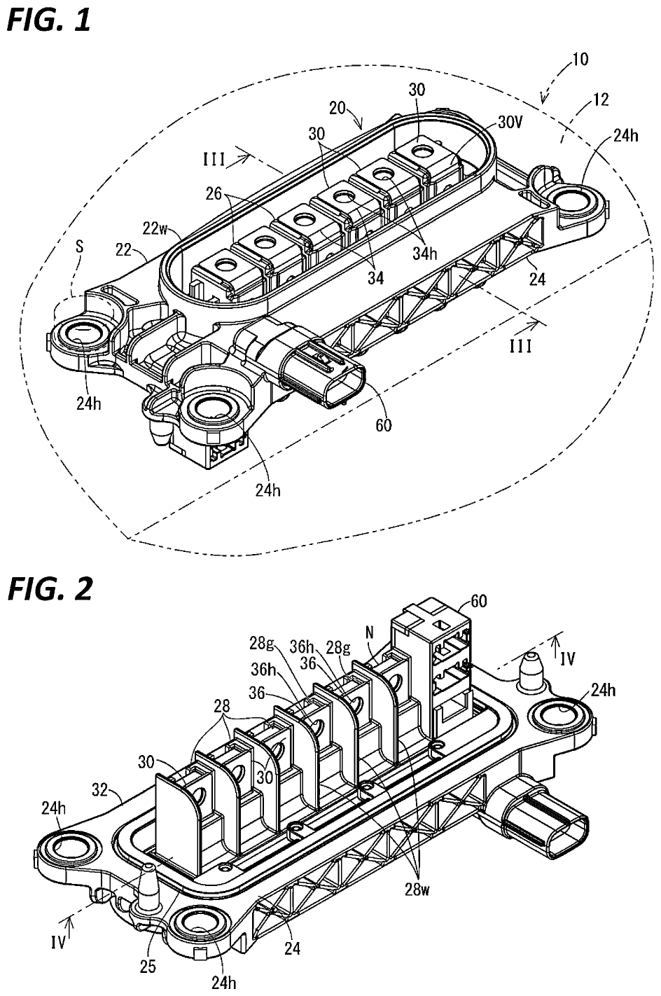

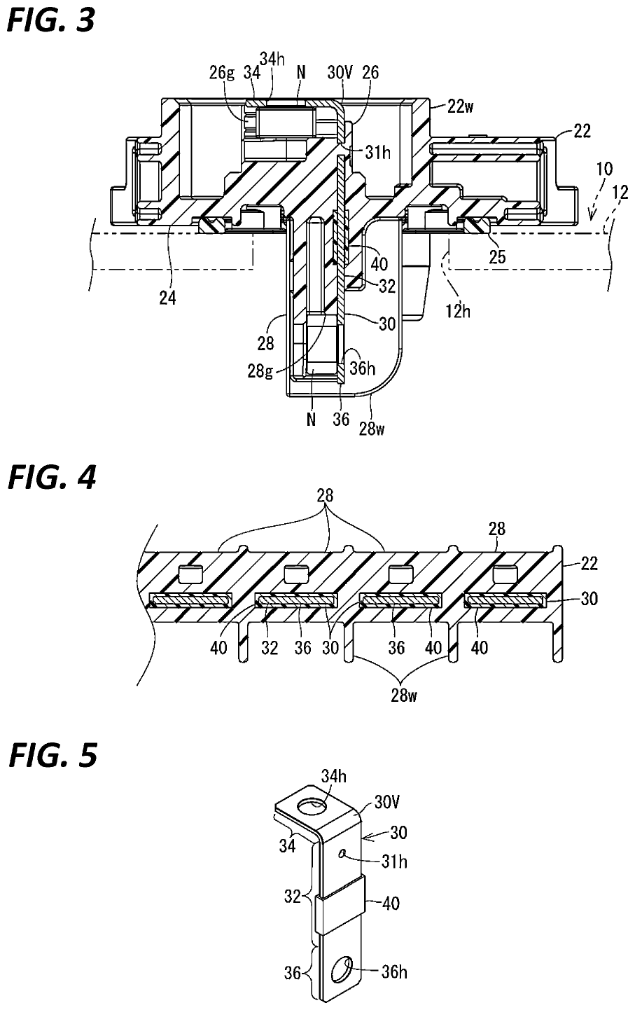

FIGS. 1 and 2 are perspective views showing a terminal block 20. FIG. 3 is a section along III-III of FIG. 1. FIG. 4 is a section along IV-IV of FIG. 2. In FIGS. 1 and 3, a device case 12 of the device 10 is shown by two-dot chain lines.

The device 10 is configured to accommodate an electrical component in the device case 12. The device case 12 is formed with a connection opening 12h. The connection opening 12h is an opening penetrating through the device case 12 in an in-out direction. The terminal 30 is arranged through this connection opening 12h. The connection opening 12h only has to be a through hole, through which the terminal 30 can be passed, and the shape thereof is not particularly limited. The connection opening 12h may be, for example, a long hole.

The terminal block 20 is provided with a resin base 22, terminals 30 and sealing portions 40. In this embodiment, the terminal block 20 is provided with a plurality of the terminals 30, more specifically, six terminals 30. The number of the terminals provided in the terminal block is arbitrary.

The resin base 22 is a part made of resin. The resin base 22 is, for example, a resin molded part.

The terminal 30 is an electrically conductive component including an insert part 32. The terminal 30 is, for example, a metal component formed by press-working a metal plate. The terminal 30 is an elongated component, and one part in a longitudinal direction thereof is the insert part 32. The insert part 32 is a part to be located in the resin base 22.

The sealing portion 40 is a part to be interposed between the insert part 32 and the resin base 22. The sealing portion 40 functions to suppress the entrance of a fluid along an interface between the insert part 32 and the resin base 22.

The sealing portion 40 is a thermally shrunk heat shrink tube in a state covering the insert part 32. The heat shrink tube is a member, which can be made thinner than an initial thickness by thermally shrinking a resin member molded into a tubular shape in advance by heat. The terminal 30 can be easily inserted through the heat shrink tube before heating thicker than the heat shrink tube after heating. Further, the heated heat shrink tube is thinned due to thermal shrinkage and pressed against a surface of the insert part 32. In this way, the inner peripheral surface of the heat shrink tube contacts the surface of the insert part 32 to seal between the insert part 32 and the sealing portion 40.

Since the sealing portion 40 covers the insert part 32, the sealing portion 40 is also located in the resin base 22. The resin base 22 is molded with the insert part 32 and the sealing portion 40 covering the insert part 32 as inserts. If a molten resin is injected into a mold, this resin flows along the outer peripheral surface of the sealing portion 40, wherefore sealing is provided also between the sealing portion 40 and the resin base 22.

Each component is more specifically described.

FIG. 5 is a perspective view showing the terminal 30 and the sealing portion 40. As shown in FIGS. 1 to 5, the terminal 30 is a member formed by stamping one metal plate. Thus, the terminal 30 has a single layer structure. The terminal 30 may be bent if necessary.

In this embodiment, the terminal 30 includes the insert part 32, a first end part 34 and a second end part 36. In an extension direction of the terminal 30, the insert part 32 is located between the first and second end parts 34, 36.

More specifically, the terminal 30 is a member formed by bending a strip-like metal plate at a bent part 30V near one end of the metal plate. In this embodiment, the bent part 30V is bent at a right angle and the terminal 30 is bent into an L shape as a whole.

Out of the terminal 30, the bent part 30V and a short side part extending from the bent part 30V toward the one end constitutes the first end part 34. The first end part 34 is formed with an insertion hole 34h.

Out of the terminal 30, an end part opposite to the first end part 34 constitutes the second end part 36. That is, an end region separated from the bent part 30V in a long side part extending from the bent part 30V toward the other end, out of the terminal 30, is the second end part 36. The second end part 36 is formed with an insertion hole 36h. The second end part 36 and a conductor to be connected can be screwed, using this insertion hole 36h.

Out of the terminal 30, a part between the first and second end parts 34, 36 is the insert part 32. That is, an intermediate region separated from the bent part 30V and near the bent part 30V in the long side part extending from the bent part 30V toward the other end, out of the terminal 30, is the insert part 32. The insert part 32 may be formed with a through hole 31h. The through hole 31h may be formed at a position near the first end part 34. The sealing portion 40 may cover the insert part 32 at a position avoiding this through hole 31h.

Note that the terminal bent halfway is not essential and the terminal may be in the form of a straight strip. Thus, it is not essential that the first end part includes the bent part. Each of the first and second end parts only has to be a part capable of contacting a conductor to be connected and may be in the form of a plate including no insertion hole. Each of the first and second end parts may also be a structure including a spring portion capable of resiliently contacting the conductor to be connected. It is not essential that the terminal is in the form of a strip. For example, the terminal may be in the form of a round or polygonal bar.

The sealing portion 40 covers the insert part 32. In this embodiment, the sealing portion 40 is in the form of a flat rectangular tube corresponding to the outer peripheral surface of the insert part 32.

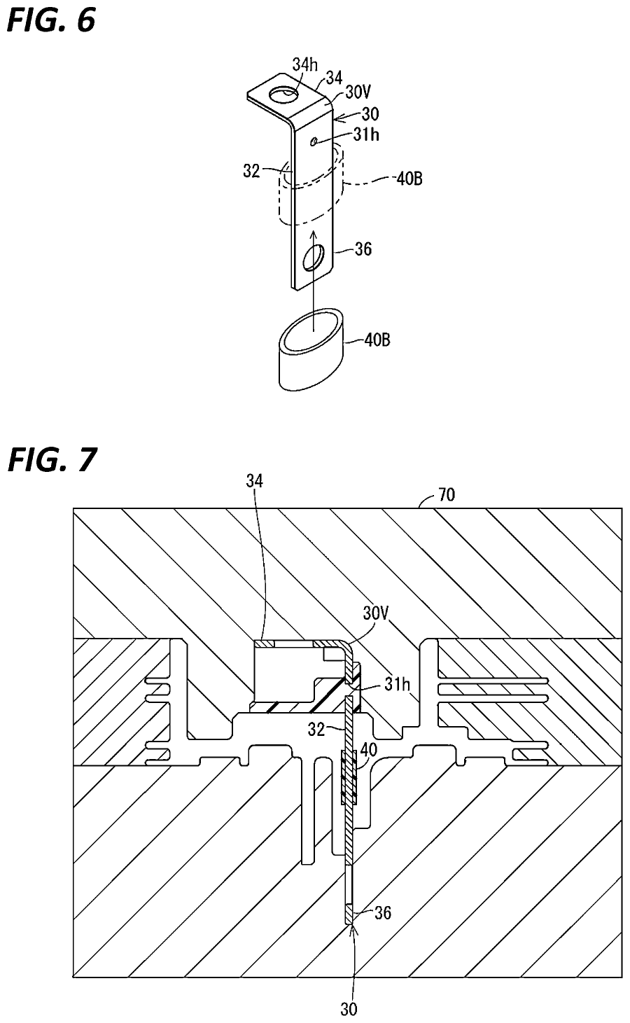

As described above, the sealing portion 40 is a thermally shrunk heat shrink tube. FIG. 6 shows a heat shrink tube 40B before thermal shrinkage.

For example, the heat shrink tube is manufactured by cooling a resin member formed into a tubular shape by extrusion molding after extending the resin member into a thicker tube in a heated state. The heat shrink tube manufactured in this way has shape memory properties of shrinking into a tube thinner than that before being extended when being heated.

An entire inner circumference of the heat shrink tube 40B before thermal shrinkage is larger than an entire outer circumference of the insert part 32, preferably larger than an entire outer circumference of the second end part 36. Thus, the second end part 36 and the insert part 32 of the terminal 30 can be easily inserted through the heat shrink tube 40B before thermal shrinkage.

In a minimum heat shrink tube state where the heat shrink tube 40B is in a minimum thermally shrinkable size, the entire inner circumference in this minimum heat shrink tube state is equal to or smaller than the entire outer circumference of the insert part 32. Thus, the heat shrink tube 40B can be thermally shrunk to tighten the insert part 32, and the sealing portion 40 can be in contact with the outer peripheral surface of the insert part 32 entirely in a circumferential direction of the insert part 32. The sealing portion 40 is kept in contact with the outer peripheral surface of the insert part 32 at least by a thermal shrinkage force of the sealing portion 40.

A thermoplastic synthetic resin can be, for example, used as a material of the heat shrink tube. A thermoplastic resin having a cross-linked structure is, for example, preferably used as the thermoplastic resin. The cross-linked structure may be obtained by irradiating an electron beam. The thermoplastic resin material may be a synthetic resin mainly containing a polyolefin-based resin such as cross-linked polyethylene or cross-linked polypropylene. If the thermoplastic resin material is a resin mainly containing the same resin as the resin base 22, adhesiveness between the sealing portion 40 and the resin base 22 is improved, but this is not essential. The thermoplastic resin material may be one type of single material or an appropriate combination of two or more types of materials.

The heat shrink tube may contain an adhesive. For example, the heat shrink tube may include a tube base portion serving as a base member and a layer of an adhesive covering the inner peripheral surface of the tube base portion. The adhesive may be a resin having a lower melting point or glass-transition temperature than the tube base portion. In this way, the adhesive is melted before the tube base portion is melted, and can be held in close contact with the inner peripheral surface of the tube base portion and the outer peripheral surface of the insert part 32.

The adhesive may adhere to the surfaces of the tube base portion and the insert part 32 by an anchor effect, by intermolecular forces or by chemical bonding.

The sealing portion 40 may cover only the insert part 32 or may cover the first end part 34 or the second end part 36. The sealing portion 40 may be entirely covered in the resin base 22. In this way, an opening of the sealing portion 40 is not exposed to outside from the resin base 22 and a fluid hardly enters a boundary between the opening of the sealing portion 40 and the terminal 30.

In this embodiment, the sealing portion 40 is located inward of a boundary between the insert part 32 and the first end part 34 and inward of a boundary between the insert part 32 and the second end part 36. Thus, the sealing portion 40 is embedded in the resin base 22, together with the insert part 32, and not exposed to outside from the resin base 22.

As shown in FIGS. 1 to 4, the resin base 22 is a part to be fixed to the device 10 while holding the terminals 30. The resin base 22 is made of resin, which is an insulator. The resin for forming the resin base 22 may be the same resin as or different from that for forming the sealing portion 40. The terminal 30 is supported at a fixed position with respect to the device 10 by the resin base 22.

The resin base 22 includes a mounting portion 24, outward extended holding portions 26 and inward extended holding portions 28.

The mounting portion 24 is a part to be mounted on the device case 12 to close the connection opening 12h of the device case 12. In this embodiment, the mounting portion 24 is shaped to close an outer opening of the connection opening 12h of the device case 12 and cover an outer opening peripheral edge part of the connection opening 12h, here in the form of a rectangular plate extending larger than the outer opening of the connection opening 12h. The mounting portion 24 may be formed with lightening recesses or reinforcing ribs.

Insertion holes 24h are formed in an outer peripheral part of the mounting portion 24, here, in respective four corner parts. The mounting portion 24 is overlapped on the outer surface of the device case 12 on the outer peripheral edge of the connection opening 12h. In this state, screws S are inserted into the insertion holes 24h and threadably fastened to nuts provided in the device case 12. In this way, the resin base 22 is fixed to the device case 12 while closing the connection opening 12h.

The mounting portion 24 includes an annular sealing portion 25 for sealing between the resin base 22 and the connection opening 12h. The annular sealing portion 25 is an annular resin member and, for example, a member made of rubber. The annular sealing portion 25 is arranged in a part facing the outer surface of the device case 12 on the outer periphery of the connection opening 12h, out of the mounting portion 24. The annular sealing portion 25 may be mounted on the mounting portion 24 by a fitting structure or the like.

With the mounting portion 24 mounted on the device case 12, the annular sealing portion 25 is interposed in a compressed state between the mounting portion 24 and the device case 12 circumferentially over the entire connection opening 12h. In this way, sealing is provided between the mounting portion 24 and the device case 12 to suppress the entrance of a fluid through a gap between the mounting portion 24 and the device case 12.

The outward extended holding portion 26 projects outwardly of the device case 12 from the mounting portion 12. The inward extended holding portion 28 projects inwardly of the device 12 from the mounting portion 24. The outward extended holding portion 26 and the inward extended holding portion 28 are located on the same straight line along an axial direction of the connection opening 12h. The insert part 32 is arranged inside the outward extended holding portion 26 and the inward extended holding portion 28 through the mounting portion 24.

A setting recess 26g capable of setting a nut N therein is formed in an outer end part of the outward extended holding portion 26. The nut N set in the setting recess 26g is facing toward a tip side of the outward extended holding portion 26. The first end part 34 is exposed from the outward extended holding portion 26 before the bent part 30V and overlapped on the nut N. In this state, the insertion hole 34h of the first end part 34 is arranged at a position overlapping a screw hole of the nut N. The first end part 34 and the conductor to be connected can be screwed, utilizing the insertion hole 34h and the nut N.

A setting recess 28g capable of setting a nut N therein is formed in an inner end part of the inward extended holding portion 28. The nut N set in the setting recess 28g is facing toward one side of a tip part of the inward extended holding portion 28. The second end part 36 is exposed from the inward extended holding portion 28 before the setting recess 28g and overlapped on the nut N. In this state, the insertion hole 36h of the second end part 36 is arranged at a position overlapping a screw hole of the nut N. The second end part 36 and the conductor to be connected can be screwed, utilizing the insertion hole 36h and the nut N.

The mating conductor connected to the first end part 34 and the mating conductor connected to the second end part 36 are electrically connected via the insert part 32.

A plurality of (here, six) combinations of the outward extended holding portion 26 and the inward extended holding portion 28 are provided to correspond to the respective terminals 30.

A plurality of the outward extended holding portions 26 are arranged at intervals in a longitudinal direction of the connection opening 12h. The resin base 22 includes a peripheral wall 22w surrounding the plurality of outward extended holding portions 26 arranged at intervals.

A plurality of the inward extended holding portions 28 are successively arranged in the longitudinal direction of the connection opening 12h. Partition walls 28w are provided between the respective inward extended holding portions 28.

The respective terminals 30 are held in parallel at intervals in the resin base 22. The plurality of terminals 30 are held in a state insulated from each other by the resin base 22.

Out of the terminal 30, the insert part 32 is embedded in the resin base 22. With the resin base 22 mounted on the device case 12, the first end part 34 is exposed from the outward extended holding portion 26 and facing outward of the device case 12. In this state, the second end part 36 is exposed form the inward extended holding portion 28 and facing inward of the device case 12 through the connection opening 12h.

In this embodiment, the terminal block 20 is provided with a relay connector device 60. The relay connector device 60 is a device for relay-connecting a connector in the device case 12 and a connector outside the device case 12, separately from the above terminals 30. The relay connector device 60 may be omitted.

### Manufacturing Method Example

A manufacturing method example of the terminal block 20 is described.

As shown in FIG. 6, the heat shrink tube 40B before thermal shrinkage cut to a length suitable to cover a part in the longitudinal direction of the insert part 32 is prepared. Then, the insert part 32 of the terminal 30 is passed through the heat shrink tube 40B. An operation of inserting the insert part 32 through the heat shrink tube 40B may be performed by an automatic insertion robot.

In this state, the heat shrink tube 40B is heated. Then, the heat shrink tube 40B thermally shrinks and is held in close contact with the outer periphery of the insert part 32. The heat shrink tube 40B can thermally shrink, for example, within less than one minute. Thus, a mounting operation of the sealing portion 40 on the insert part 32 can be performed in a short time.

To hold the heat shrink tube 40B at a fixed position with respect to the insert part 32 during thermal shrinkage, the heat shrink tube 40B may be temporarily bonded to the insert part 32 by an adhesive. A bonding operation using the adhesive may be performed by an automatic robot.

Thereafter, as shown in FIG. 7, the terminal 30 mounted with the sealing portion 40 is set in a mold for molding the resin base 22. At this time, the first and second end parts 34, 36 are set in positioning recesses formed in the mold 70 and the insert part 32 is arranged in a mold inner space. Note that if a part difficult to form by one molding is present in the resin base 22, the resin base 22 may be formed separately as a primary molding part and a secondary molding part, or may be molded using a core. In an example shown in FIG. 7, the terminal 30 primarily molded with an end of the inward extended holding portion 28 of the resin base 22 is set in the mold 70.

By injecting the molten resin into the mold space, the molten resin fills a gap between the insert part 32, the sealing portion 40 and a mold surface. Thereafter, the molten resin is cooled and cured. Thus, the resin constituting the resin base 22 is cured while being held in close contact with the surface of the sealing portion 40 according to a filling pressure during injection molding. The resin constituting the resin base 22 may adhere to the surface of the sealing portion 40 by an anchor effect, by intermolecular forces or by chemical bonding.

The resin and the surface of the sealing portion 40 may more closely adhere by melting the surface of the sealing portion 40 by the temperature of the resin injected into the mold 70.

Note that, even if the temperature of the resin injected into the mold 70 exceeds a melting point of the sealing portion 40, at least a contact state of the terminal 30 and the sealing portion 40 can remain in a state during thermal shrinkage due to an exposure time of the sealing portion 40 to the hot resin and the like. Further, by properly setting conditions during molding, a thickness of the sealing portion 40 can be maintained constant.

### Effects

According to the terminal block 20 configured as described above, the sealing portion 40 is the thermally shrunk heat shrink tube in the state covering insert part 32. Thus, if the heat shrink tube 40B is thermally shrunk by heating after the terminal 30 is passed through the heat shrink tube 40B before thermal shrinkage, the heat shrink tube can be easily mounted as the sealing portion 40 on the terminal 30. Further, the sealing portion 40 obtained by thermally shrinking the heat shrink tube 40B surrounds the insert part 32 while having a uniform thickness and a uniform width. Thus, a state where the sealing portion 40 covers the insert part 32 is stabilized and sealability can be expected to improve.

Further, the operation of inserting the terminal 30 through the heat shrink tube 40B is easy and the operation of thermally shrinking the heat shrink tube 40B is also easily performed in a short time. Thus, the terminal block 20 in which the sealing portions 40 are provided on the insert parts 32 can be easily manufactured in a short time.

That is, a heat shrink tube is normally used for the purpose of mechanically protecting, waterproofing or insulate a wire. Note that waterproofing is for making a part covered with the heat shrink tube waterproof from outside, and different in principle from the suppression of the entrance of a fluid along a surface of the part covered with the heat shrink tube. In view of these purposes, the insert part 32 is covered by the resin base 22 and the mechanical protection, exterior waterproofing and insulation purposes are realized. Thus, in view of general purposes of the heat shrink tube, it cannot be assumed to cover the insert part 32 with the heat shrink tube.

By the present inventor's unique point of view, it was found out that the entrance of a fluid along between the insert part 32 and the resin base 22 was suppressed by interposing the sealing portion 40 formed by the thermally shrunk heat shrink tube between the insert part 32 and the resin base 22. In this way, sealability between the both ends of the terminal 30 in the terminal block 20 can be improved by an easy operation of forming the sealing portion 40.

Further, the terminal 30 is one type of relay terminal including the first and second end parts 34, 36. By electrically connecting the first and second end parts 34, 36 to separate electrically conductive paths, the separate electrically conductive paths are electrically connected via the terminal 30. The sealing portion 40 for providing sealability to the terminal 30 for relay-connecting the separate electrically conductive paths can be easily mounted on the insert part 32.

Further, the resin base 22 is one type of terminal block to be mounted on the device case 12. With the resin base 22 covering the connection opening 12h, the terminal 30 is passed through the resin base 22, the first end part 34 is facing outward of the device case 12 and the second end part 36 is facing inward of the device case 12. Thus, the electrically conductive path inside the device case and the electrically conductive path outside the device case are electrically connected via the terminal 30. In this case, the resin base 22 can function to seal between the inside and outside of the device case 12 by closing the connection opening 12h. The intrusion of the fluid along the terminal 30 passed through the resin base 22 is suppressed by the sealing portion 40. Thus, sealability is improved inside and outside the device case 12.

Further, since the entire sealing portion 40 is covered in the resin base 22, the boundary between the terminal 30 and the sealing portion 40, particularly the boundary between the opening of the sealing portion 40 and the terminal 30, is covered in the resin base 22. Thus, the entrance of the fluid along the terminal 30 is more reliably suppressed.

### Modifications

Note that the electrical connection device may not be the terminal block. The electrical connection device may be a connector with a terminal in a resin formed by insert molding or a configuration in which a terminal is directly mounted in a housing of a device by insert molding.

Note that the respective configurations described in the above embodiment and the respective modifications can be appropriately combined without contradicting each other.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. An electrical connection device, comprising:
a resin base;
a terminal including an insert part located in the resin base; and
a sealing portion interposed between the insert part and the resin base,
the sealing portion being a thermally shrunk heat shrink tube in a state covering the insert part.

2. The electrical connection device of claim 1, wherein:
the terminal includes a first end part and a second end part and the insert part is located between the first and second end parts, and
the insert part is located in the resin base with the first and second end parts exposed from the resin base.

3. The electrical connection device of claim 2, wherein:
the resin base includes a mounting portion to be mounted on a device case to close a connection opening of the device case, and
the terminal is so supported in the resin base that the first end part is facing outward of the device case and the second end part is facing inward of the device case through the connection opening with the resin base mounted on the device case.

4. The electrical connection device of claim 1, wherein the entire sealing portion is covered in the resin base.
